(19) United States
(12) Patent Application Publication
(10) Pub. No.: US 2026/0155698 A1
(43) Pub. Date: Jun. 4, 2026

(54) VIBRATION MOTOR

(71) Applicant: AAC Microtech (Changzhou) Co., Ltd., Changzhou City (CN)

(72) Inventors: Xixi Zou, Changzhou (CN); Hongmei Yan, Changzhou (CN); Xia Zheng, Changzhou (CN)

(21) Appl. No.: 19/186,581

(22) Filed: Apr. 22, 2025

Related U.S. Application Data
(63) Continuation of application No. PCT/CN2024/136084, filed on Dec. 2, 2024.

(51) Int. Cl. H02K 5/04; H02K 33/02

(52) U.S. Cl. CPC H02K 5/04; H02K 33/02

(57) ABSTRACT

A vibration motor is provided and includes a mover, a stator, and elastic members, where the mover includes a cover plate, the stator includes a housing and an electromagnet, where the cover plate and the housing are connected by the elastic members and define an accommodation space, the electromagnet is accommodated in the accommodation space. When a periodic current is applied to the winding, the stator generates a periodic magnetic attraction force to the mover to cause the mover to move in a second direction perpendicular to the first direction. The vibration motor of the disclosure has simple structure, is easy to assemble, effectively reduces production requirements and production costs, and has controllable vibration sensation, thereby realizing different vibration sensation experiences and meeting performance requirements of various scenes.

### CROSS REFERENCE TO RELATED APPLICATIONS

The present application is a continuation of PCT Patent Application No. PCT/CN2024/136084, filed December 2, 2024, which is incorporated by reference herein in its entirety.

### TECHNICAL FIELD

The various embodiments described in this document relate in general to the field of vibration devices, and more specifically to a vibration motor.

### BACKGROUND

In the related technologies, more common vibration devices include linear motors and rotary motors. The linear motor has many parts, and the structure and assembly process of the linear motor are extremely complicated. Therefore, the cost of the linear motor in the related technologies is high. Although the structure of the rotary motor is simpler than that of the linear motor, the rotary motor has slow response and weak high-frequency vibration sensation, which is difficult to meet the performance requirements in most scenarios and is only suitable for application scenarios with low performance requirements.

Therefore, it is necessary to provide a vibration motor that is simple in structure, easy to assemble, and capable of improving vibration sensitivity.

### SUMMARY

Embodiments of the disclosure provide a vibration motor, aiming to solve the technical problems in the related technologies, such as the complex structure and assembly process of vibration devices, as well as the weak vibration sensation.

The technical solutions of the present disclosure are as follows.

A vibration motor is provided and includes a vibration motor, comprising a mover, a stator, and elastic members, where the mover includes a cover plate, and the stator includes a housing and an electromagnet, where the cover plate and the housing are connected by the elastic members and define an accommodation space, the electromagnet is accommodated in the accommodation space, and the electromagnet includes at least one winding, a first iron core, a second iron core, and a third iron core. The first iron core, the second iron core, and the third iron core are fixed to the housing, the second iron core and the third iron core are provided symmetrically on both sides of the first iron core in a first direction and are both spaced apart from the first iron core, and the at least one winding surrounds the first iron core and is located between the second iron core and the third iron core. In response to a periodic current being applied to the at least one winding, the stator generates a periodic magnetic attraction force to the mover to cause the mover to move in a second direction perpendicular to the first direction.

In some embodiments, the housing includes a first housing portion, a second housing portion, and a third housing portion. The second housing portion and the third housing portion are symmetrically fixed to the first housing portion in a third direction, and the third direction is perpendicular to the first direction and the second direction. The first iron core is fixed to the first housing portion, the second iron core has an end fixed to the second housing portion and has another end fixed to the third housing portion, and the third iron core has an end fixed to the second housing portion and has another end fixed to the third housing portion.

In some embodiments, the first housing portion defines a first insertion hole, the second housing portion defines two second insertion holes symmetrically defined in the first direction, and the third housing portion defines third insertion holes that are in one-to-one correspondence with the two second insertion holes. The first iron core includes a first main body surrounded by the at least one winding and a first insertion portion protruding from the first main body, and the first insertion portion is inserted into the first insertion hole. The second iron core includes a second main body and two second insertion portions symmetrically arranged on both sides of the second main body in the third direction. One of the two second insertion portions is inserted into one second insertion hole of the two second insertion holes, and another second insertion portion of the two second insertion portions is inserted into a third insertion hole corresponding to the one second insertion hole. The third iron core includes a third main body and two third insertion portions symmetrically arranged on both sides of the third main body in the third direction. One of the two third insertion portions is inserted into another second insertion hole of the two second insertion holes, and another third insertion portion of the two third insertion portions is inserted into a third insertion hole corresponding to the other second insertion hole.

In some embodiments, the housing is a one-piece formed structure, or the housing is a split structure, and each of the second housing portion and the third housing portion is fixed to the first housing portion through first fixing members.

In some embodiments, the vibration motor includes two elastic members provided symmetrically in the first direction. Each respective elastic member of the two elastic members includes a first connection portion, a second connection portion formed by extending from a middle of the first connection portion in the first direction, and a first convex portion provided at a free end of the second connection portion. The first connection portion has an end fixed to the second housing portion and has another end fixed to the third housing portion, and the first convex portion is protruded on a side of the second connection portion facing the cover plate and fixed to the cover plate.

In some embodiments, the respective elastic member further comprises a second convex portion formed at an end of two ends of the first connection portion in the third direction, and a third convex portion formed at another end of the two ends of the first connection portion in the third direction. The second convex portion and the third convex portion are symmetrically disposed with respect to the first connection portion, and are protruded on a side of the first connection portion facing the housing. The respective elastic member further comprises a fourth insertion portion protruding from a side of the second convex portion facing the housing, and a fifth insertion portion protruding from a side of the third convex portion facing the housing. The second housing portion defines two fourth insertion holes. The two fourth insertion holes are symmetrically defined at both ends of the second housing portion in the first direction, and are provided corresponding to the fourth insertion portions. The third housing portion defines two fifth insertion holes. The two fifth insertion holes are symmetrically defined at both ends of the third housing portion in the first direction, and are provided corresponding to the fifth insertion portions. The respective elastic member further defines a fourth insertion hole defined on the side of the second convex portion facing the housing, and a fifth insertion hole defined on the side of the third convex portion facing the housing. The second housing portion further comprises the fourth insertion portions. The fourth insertion portions are symmetrically formed at both ends of the second housing portion in the first direction, and are provided corresponding to the two fourth insertion holes. The third housing portion further comprises the fifth insertion portions. The fifth insertion portions are symmetrically formed at both ends of the third housing portion in the first direction, and are provided corresponding to the two fifth insertion holes.

In some embodiments, the second housing portion includes a first plate body and first column bodies formed symmetrically on both sides of the first plate body in the first direction, each respective first column body of the first column bodies has a first stepped surface on a side of the respective first column body facing the elastic members and abutting on the second convex portion, and the fourth insertion hole or the fourth insertion portion is provided on the first stepped surface. The third housing portion includes a second plate body and second column bodies formed symmetrically on both sides of the second plate body in the first direction, each respective second column body of the second column bodies has a second stepped surface on a side of the respective second column body facing the elastic members and abutting on the third convex portion, and the fifth insertion hole or the fifth insertion portion is provided on the second stepped surface. The first column bodies and the second column bodies are arranged in one-to-one correspondence, and a distance between a respective one of the first column bodies and a corresponding one of the second column bodies is smaller than a distance between the first plate body and the second plate body. The second iron core has an end fixed to the first plate body and has another end fixed to the second plate body, and the third iron core has an end fixed to the first plate body and has another end fixed to the second plate body.

In some embodiments, the housing is made of a highly magnetic permeable material.

In some embodiments, each of the first iron core, the second iron core, and the third iron core is made of a highly magnetic permeable material.

In some embodiments, the at least one winding is embodied as a plurality of windings, and the plurality of windings are coaxially disposed and sequentially sleeved on the first iron core.

In some embodiments, each of at least one of the first iron core, the second iron core, and the third iron core is formed by laminating a plurality of layers of iron sheets.

The beneficial effects of the present disclosure are as follows. The vibration motor of the present disclosure includes the mover, the stator and the elastic members. The mover includes the cover plate, and the stator includes the housing and the electromagnet. The cover plate and the housing are connected by the elastic members and define the accommodation space. The electromagnet is accommodated in the accommodation space. The electromagnet includes the winding, as well as the first iron core, the second iron core and the third iron core that are fixed to the housing. The second iron core and the third iron core are symmetrically arranged on both sides of the first iron core in a first direction and spaced apart from the first iron core. The winding surrounds the first iron core and is located between the second iron core and the third iron core. The structure is simple and easy to assemble, which effectively reduces the production requirements and costs. When a periodic current is applied to the winding, the stator generates a periodic magnetic attraction force on the mover. This magnetic attraction force serves as an excitation source to make the mover move in the second direction perpendicular to the first direction. The vibration motor of the present disclosure has high space utilization and large magnetic attraction force, which can provide a stronger vibration experience. In addition, the structure responds quickly without delay effect, and the vibration sensation is controllable. Specifically, by changing the frequency of the current, the vibration frequency of the mover can be changed, and by changing the amplitude of the current, the vibration amplitude of the mover can be changed, so as to achieve different vibration experiences and meet the performance requirements of various scenarios.

### BRIEF DESCRIPTION OF THE DRAWINGS

FIG. 1 is a schematic structural diagram of a vibration motor according to the present disclosure.

FIG. 2 is a front view of the vibration motor shown in FIG. 1.

FIG. 3 is a right view of FIG. 2.

FIG. 4 is a cross-sectional view taken along line A-A of FIG. 3.

FIG. 5 is an explosion view of the vibration motor shown in FIG. 1.

FIG. 6 is an enlarged view of a stator in the vibration motor shown in FIG. 5.

FIG. 7 is an enlarged view of an elastic member in the vibration motor shown in FIG. 5.

FIG. 8 is a schematic view of the vibration motor shown in FIG. 5 from another perspective.

FIG. 9 is an enlarged view of an elastic member in the vibration motor shown in FIG. 8.

FIG. 10 is an explosion view of a stator of the vibration motor shown in FIG. 1.

FIG. 11 is a schematic view of the stator shown in FIG. 10 from another perspective.

1-mover (11-cover plate), 2-stator (21-housing (211-first housing portion (2111-first insertion hole), 212-second housing portion (2121-second insertion hole, 2122-fourth insertion hole, 2123-first plate body, 2124-first column body, 2125-first stepped surface), 213-third housing portion (2131-third insertion hole, 2132-fifth insertion hole, 2133-second plate body, 2134-second column body, 2135-second stepped surface)), 22-electromagnet (221-winding, 222-first iron core (2221-first main body, 2222-first insertion portion), 223-second iron core (2231-second main body, 2232-second insertion portion), 224-third iron core (2241-third main body, 2242-third insertion portion), 3-elastic member (31-first connection portion, 32-second connection portion, 33-first convex portion, 34-second convex portion, 35-third convex portion, 36-fourth insertion portion, 37-fifth insertion portion), 4- accommodation space, 5-first fixing member, 6-third fixing member.

### DETAILED DESCRIPTION OF THE EMBODIMENTS

The disclosure will be further described below with reference to the accompanying drawings and embodiments.

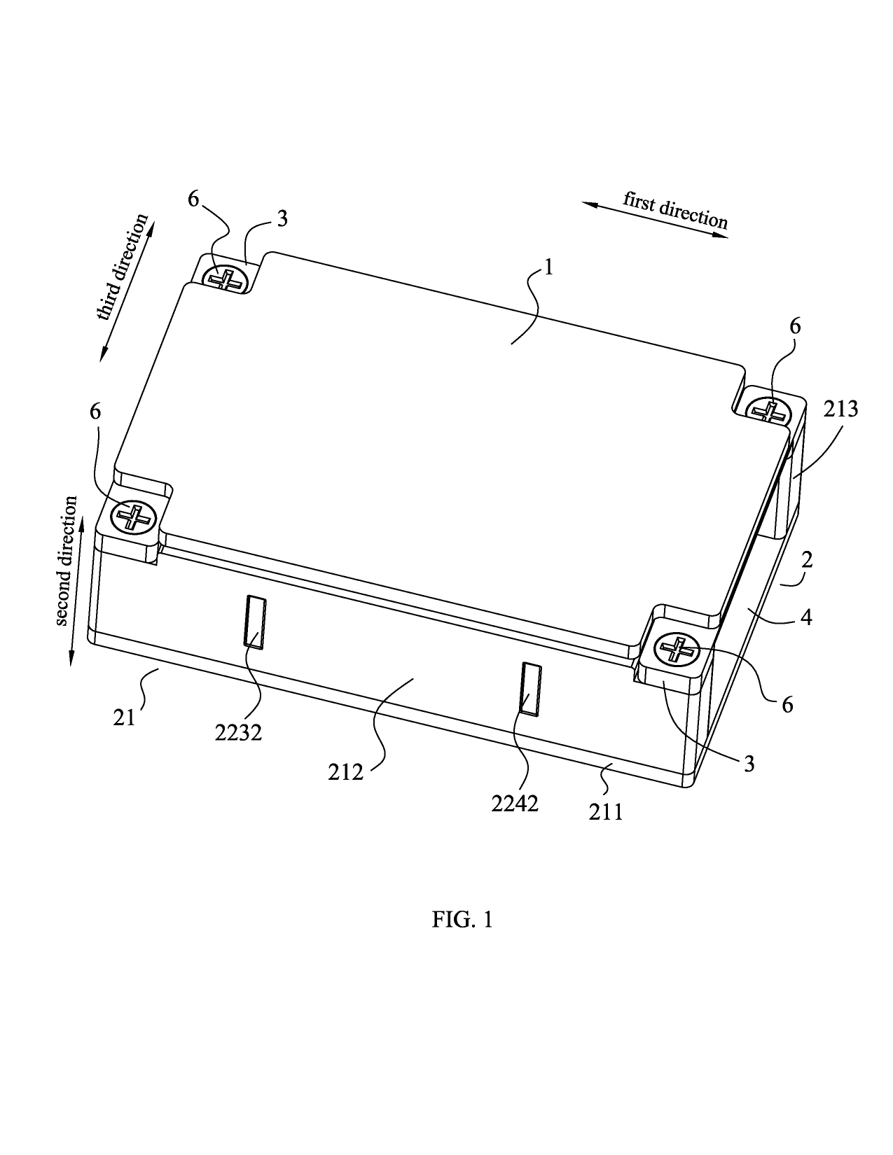

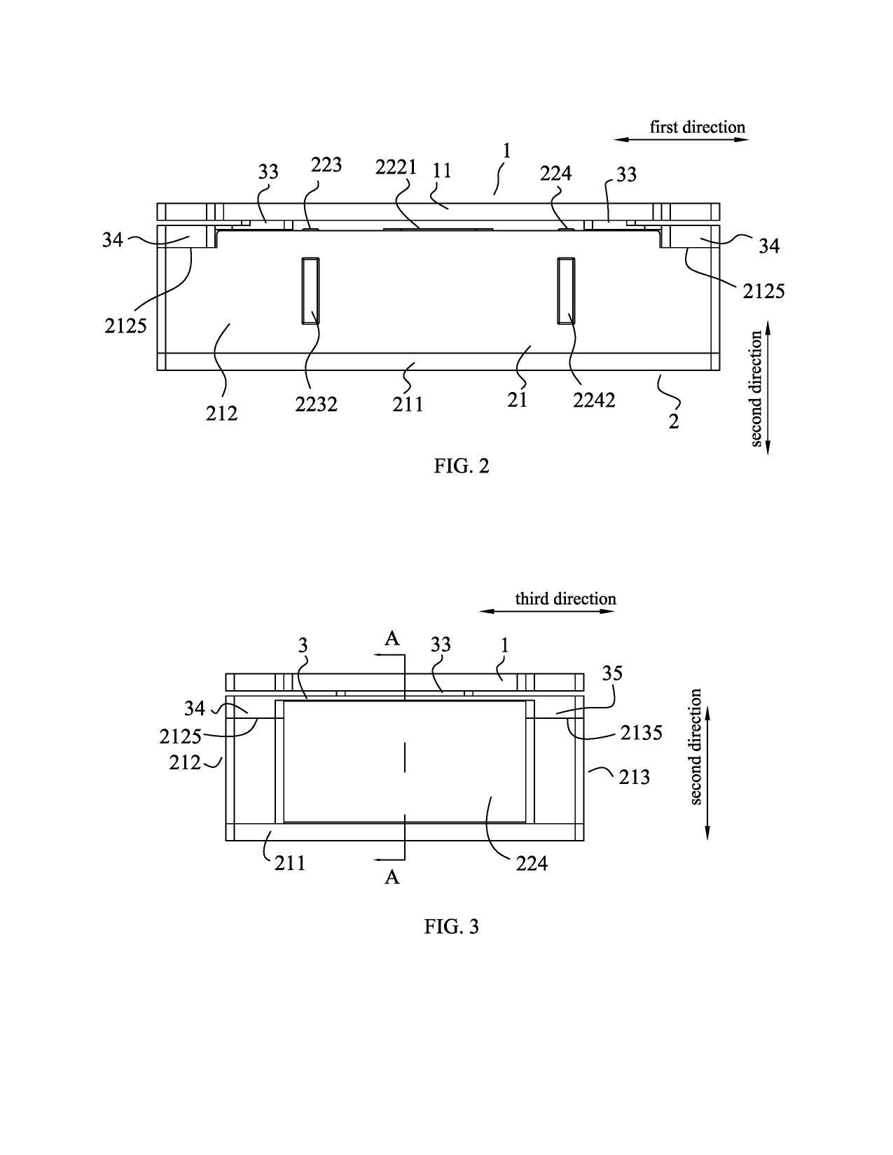

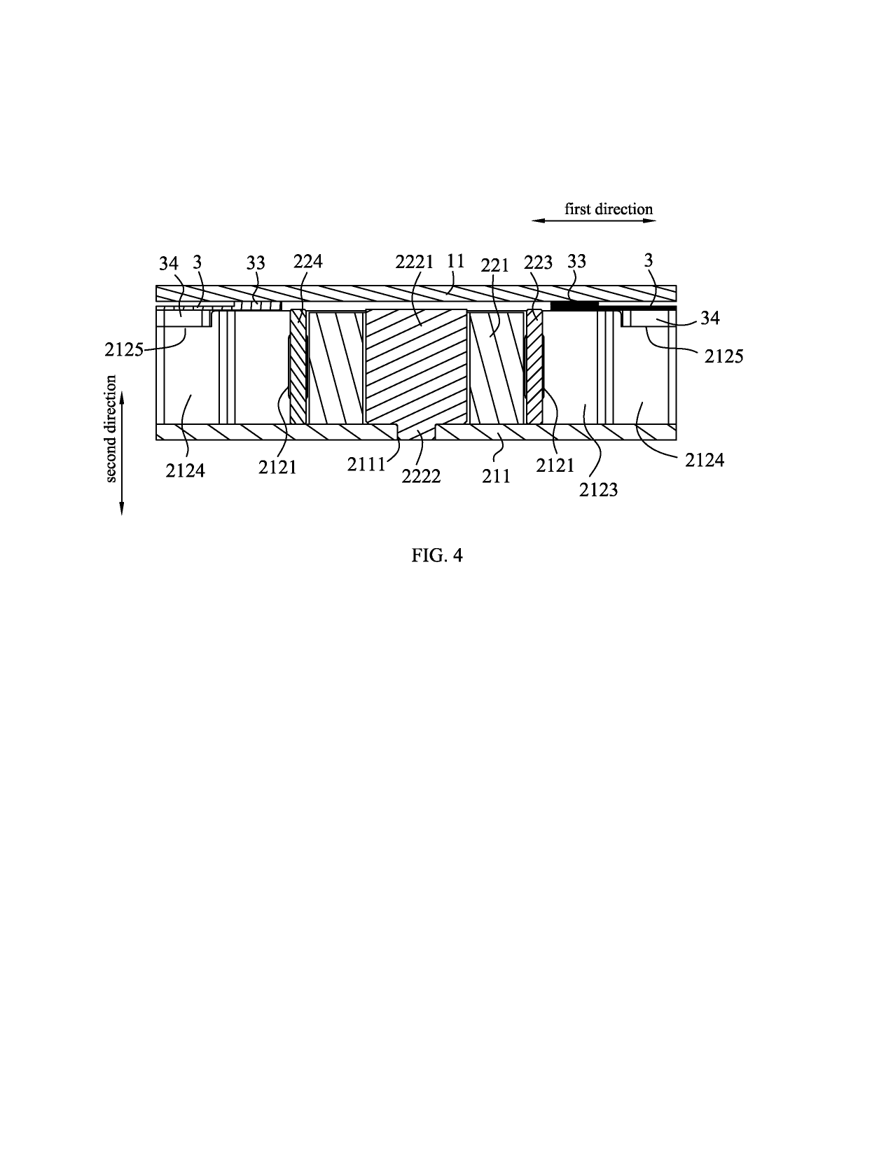

Referring to FIGS. 1 to 11, an embodiment of the present disclosure provides a mover 1, a stator 2, and elastic members 3. The mover 1 includes a cover plate 11, and the stator 2 includes a housing 21 and an electromagnet 22. The cover plate 11 and the housing 21 are connected by the elastic members 3. The cover plate 11 and the housing 21 define an accommodation space 4. The electromagnet 22 is accommodated in the accommodation space 4, and includes at least one winding 221, a first iron core 222, a second iron core 223, and a third iron core 224. The first iron core 222, the second iron core 223, and the third iron core 224 are fixed to the housing 21. The second iron core 223 and the third iron core 224 are provided symmetrically on both sides of the first iron core 222 in a first direction. The second iron core 223 and the first iron core 222 are separated from each other and the third iron core 224 and the first iron core 222 are separated from each other. The winding 221 surrounds the first iron core 222, and the winding 221 is located between the second iron core 223 and the third iron core 224. When a periodic current is applied to the winding 221, the stator 2 generates a periodic magnetic attraction force to the mover 1, to cause the mover 1 to move in a second direction perpendicular to the first direction.

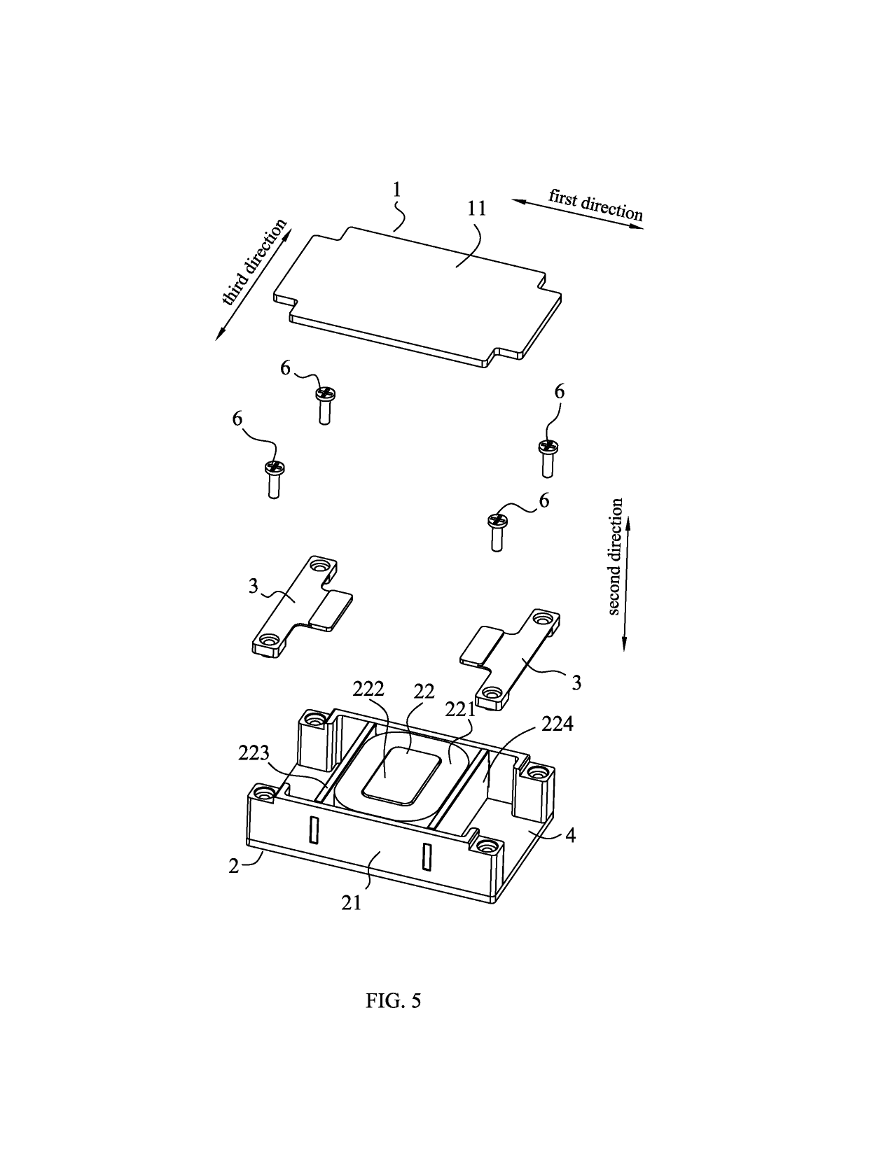

In embodiments of the present disclosure, referring to FIG. 5, the vibration motor includes the mover 1, the stator 2, and the elastic members 3. The mover 1 includes the cover plate 11, and the stator 2 includes the housing 21 and the electromagnet 22. The cover plate 11 and the housing 21 are connected by the elastic members 3 and define the accommodation space 4. The electromagnet 22 is accommodated in the accommodation space 4. The electromagnet 22 includes the at least one winding 221, and the first iron core 222, the second iron core 223, and the third iron core 224 that are fixed to the housing 21. The second iron core 223 and the third iron core 224 are provided symmetrically on both sides of the first iron core 222 in the first direction and are both spaced apart from the first iron core 222. The at least one winding 221 surrounds the first iron core 222, and the at least one winding 221 is located between the second iron core 223 and the third iron core 224, which is simple in structure, low in production costs, and is easy to assemble and disassemble, thereby further reducing production requirements and costs. When a periodic current is applied to the at least one winding 221, the stator 2 generates a periodic magnetic attraction force to the mover 1, and the magnetic attraction force acts as an excitation source to cause the mover 1 to move in the second direction. The vibration motor of the disclosure has high space utilization ratio, large magnetic attraction force, can provide more powerful vibration sensing experience, quick response, no delay effect, and controllable vibration sensing. Specifically, by changing a frequency of the current, a vibration frequency of the mover 1 can be changed, and by changing an amplitude of the current, a vibration amplitude of the mover 1 can be changed, so as to realize different vibration sensing experiences and meet the performance requirements of various scenes. For example, embodiments of the present disclosure may be applicable to vehicles and other related fields.

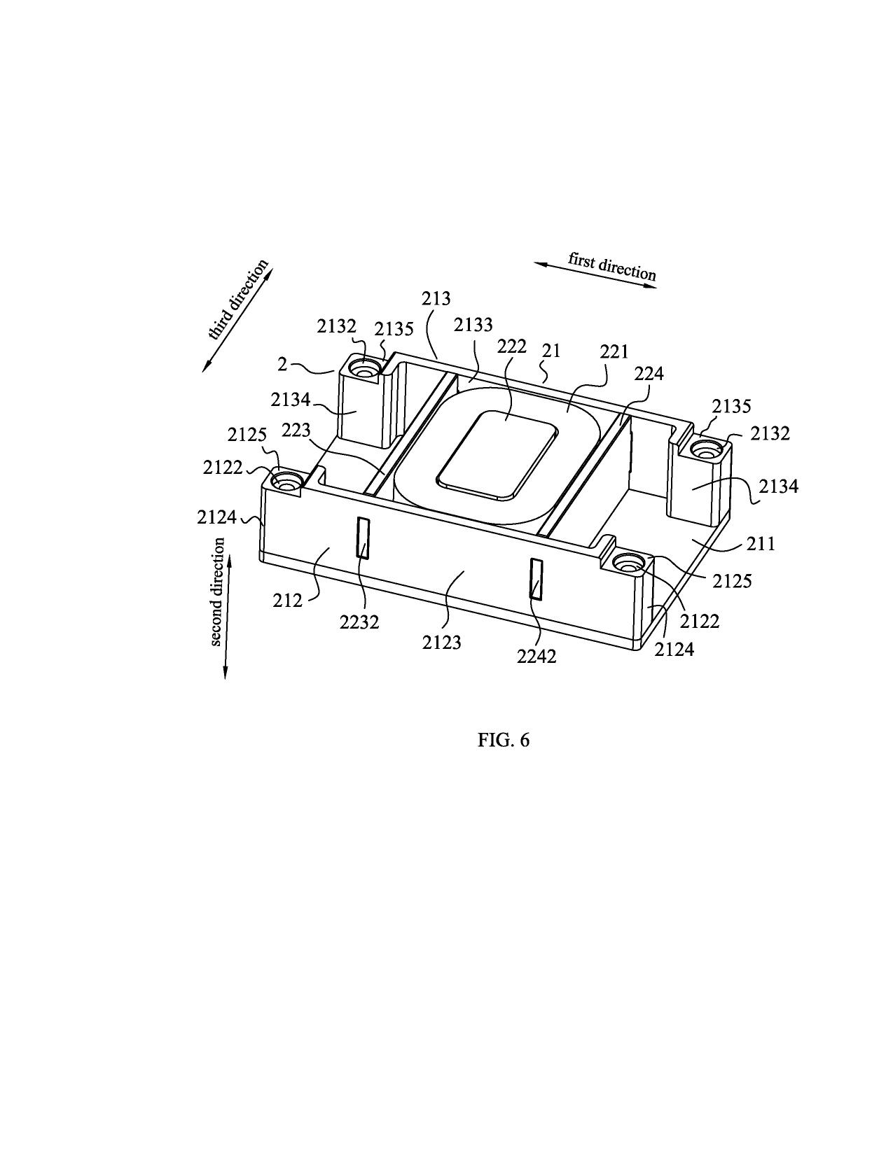

Specifically, referring to FIGS. 6, 8, and 10, the housing 21 may include a first housing portion 211, a second housing portion 212, and a third housing portion 213. The second housing portion 212 and the third housing portion 213 are symmetrically fixed to the first housing portion 211 in a third direction. The third direction is perpendicular to the first direction and the second direction. As an example, the first direction may be an X direction, the second direction may be a Z direction, and the third direction may be a Y direction. Accordingly, the first iron core 222 is fixed to the first housing portion 211. An end of the second iron core 223 is fixed to the second housing portion 212, and the other end of the second iron core 223 is fixed to the third housing portion 213. An end of the third iron core 224 is fixed to the second housing portion 212, and the other end of the third iron core 224 is fixed to the third housing portion 213, which is not only simple in structure and easy to assemble. In addition, both the second iron core 223 and the third iron core 224 are fixed between the second housing portion 212 and the third housing portion 213, which can also effectively limit the distance between the second housing portion 212 and the third housing portion 213, making the overall structure of the vibration motor more stable.

As an example, when a current is applied to the winding 221, the stator 2 including the first iron core 222, the second iron core 223, the third iron core 224, and the first housing portion 211 forms a magnetic circuit with the mover 1 including the cover plate 11, and the stator 2 generates a magnetic attraction force to the mover 1, where the magnitude of the magnetic attraction force have a positive correlation with the magnitude of the current. When a periodic current is applied to the winding 221, the stator 2 may generate a periodic magnetic attraction force to the mover 1, and the magnetic attraction force acts as an excitation source to cause the mover 1 to move in the second direction. In addition, the vibration frequency can be changed by changing the frequency of the current, and the vibration amplitude can be changed by changing the amplitude of the current, thereby realizing different vibration sensing experience.

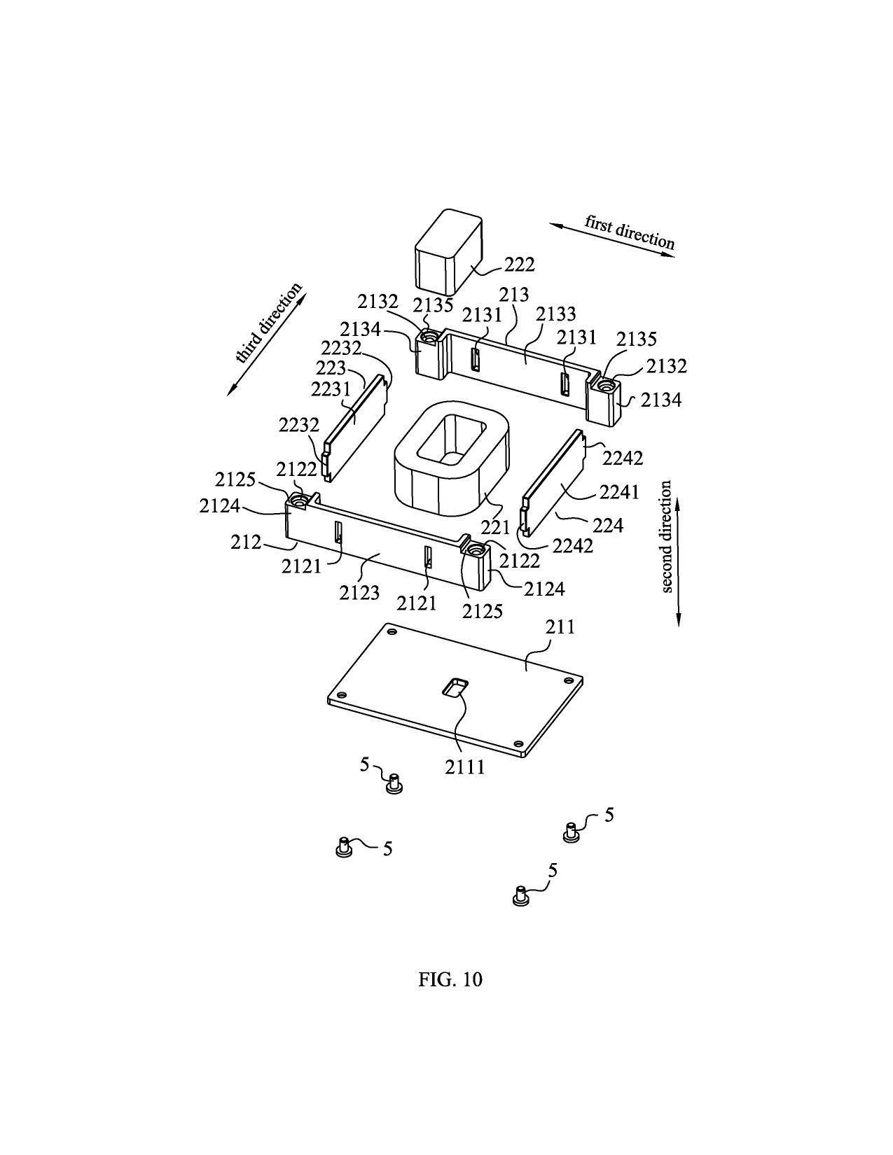

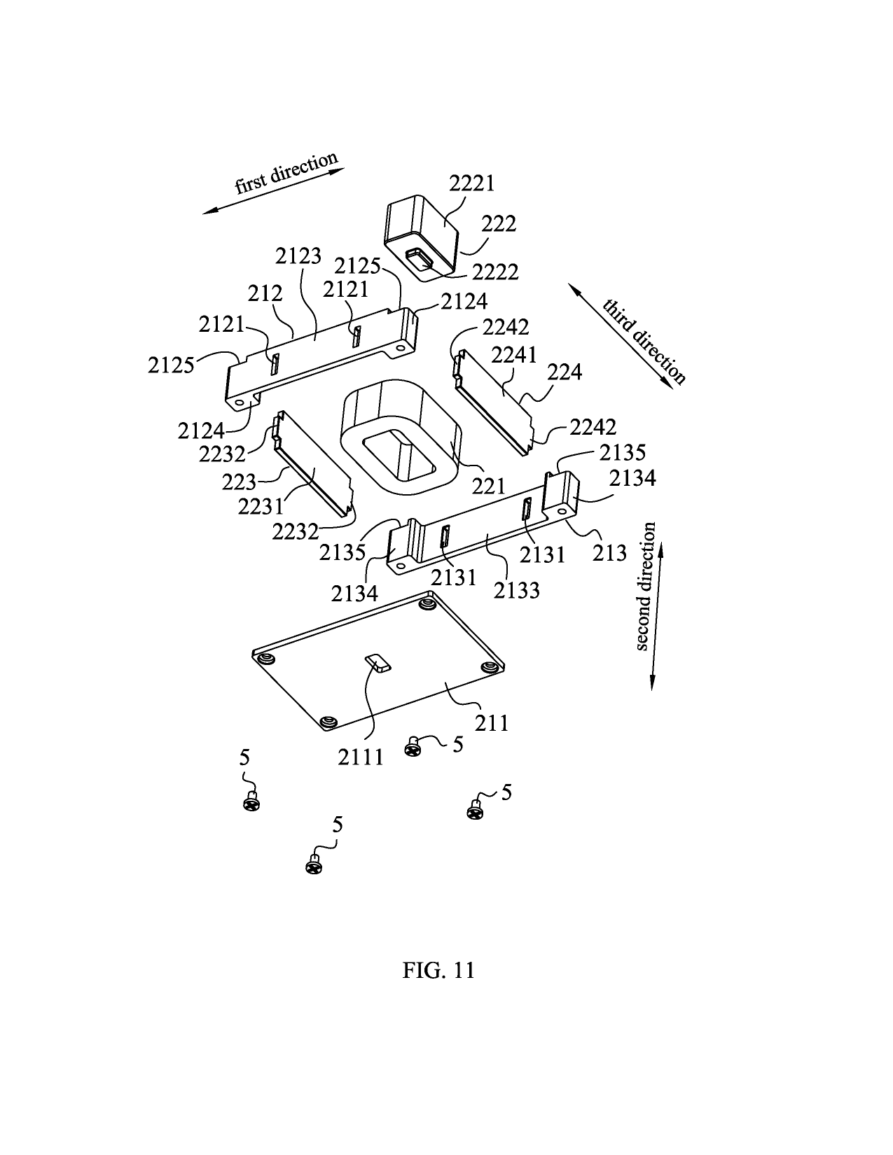

In some embodiments, referring to FIGS. 10 and 11, the first housing portion 211 defines a first insertion hole 2111, the second housing portion 212 defines two second insertion holes 2121 symmetrically defined in the first direction, and the third housing portion 213 defines third insertion holes 2131 that are in one-to-one correspondence with the two second insertion holes 2121. The first iron core 222 includes a first main body 2221 and a first insertion portion 2222 integrally connected. The winding 221 surrounds the first main body 2221, the first insertion portion 2222 protrudes from the first main body 2221, and the first insertion portion 2222 is inserted into the first insertion hole 2111. The second iron core 223 includes a second main body 2231 and two second insertion portions 2232, and the two second insertion portions 2232 are symmetrically provided on both sides of the second main body 2231 in the third direction. One of the two second insertion portions 2232 is inserted into one second insertion hole 2121 of the two second insertion holes 2121, and the other of the two second insertion portions 2232 is inserted into the third insertion hole 2131 corresponding to the one second insertion hole 2121. The third iron core 224 includes a third main body 2241 and two third insertion portions 2242, and the two third insertion portions 2242 are symmetrically provided on both sides of the third main body 2241 in the third direction. One of the two third insertion portions 2242 is inserted into another second insertion hole 2121 of the two second insertion holes 2121, and the other of the two third insertion portions 2242 is inserted into the third insertion hole 2131 corresponding to the other second insertion hole 2121.

In the present embodiment, the first iron core 222 is inserted into and cooperates/fitted with the first housing portion 211, the second iron core 223 is inserted into and fitted with the second housing portion 212 and the third housing portion 213, and the third iron core 224 is inserted into and fitted with the second housing portion 212 and the third housing portion 213, which facilitates quick and accurate installation and positioning of the first iron core 222, the second iron core 223, and the third iron core 224 into the housing 21, and makes the connection relationship between the first housing portion 211, the second housing portion 212, and the third housing portion 213 more stable, which not only improves the assembly efficiency and accuracy, but further improves the stability of the vibration motor.

In another embodiment, the first iron core 222 can also be installed and fixed to the first housing portion 211 by other means such as welding or screw connection. Each of the second iron core 223 and the third iron core 224 may be installed and fixed to the second housing portion 212 and the third housing portion 213 by other means such as welding or screw connection, and may be provided according to actual circumstances, which will not be described herein.

In some embodiments, the housing 21 may be a one-piece formed structure, that is, the first housing portion 211, the second housing portion 212, and the third housing portion 213 are integrally formed, which makes the structure of the housing 21 more stable. In addition, there is no need to be assembled to form the housing 21, thereby reducing the assembly process and further improving the assembly efficiency.

In other embodiments, the housing 21 may be a split structure, that is, the first housing portion 211, the second housing portion 212, and the third housing portion 213 are assembled to form the housing 21, which can reduce the difficulty of production of parts of the housing 21, and facilitate the installation of the first iron core 222, the second iron core 223, and the third iron core 224 into the housing 21, thereby reducing the difficulty of assembly.

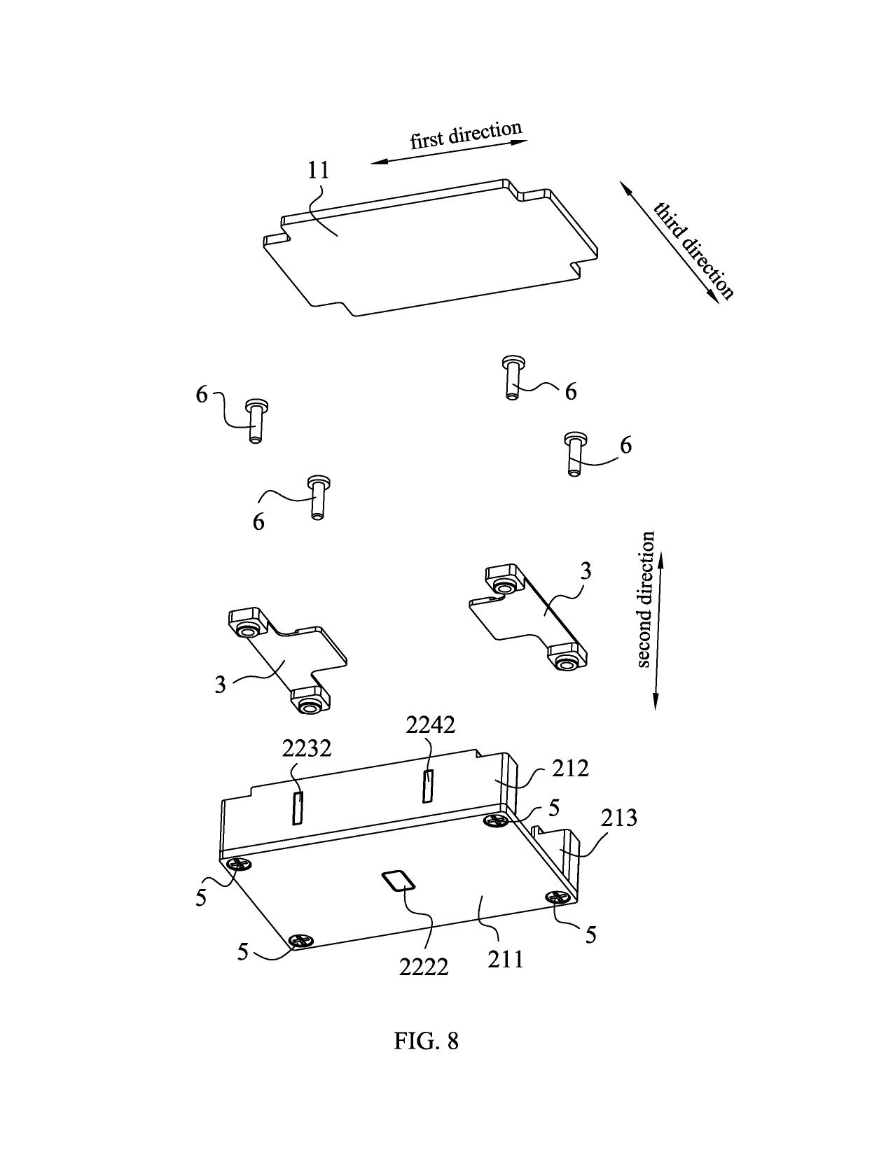

As an example, referring to FIGS. 8 and 10, the second housing portion 212 may be fixed to the first housing portion 211 by first fixing members 5, and the third housing portion 213 may be fixed to the first housing portion 211 by other first fixing members 5. For example, each first fixing member 5 may be a screw, the second housing portion 212 may be fixed to the first housing portion 211 by screws, and the third housing portion 213 may be fixed to the first housing portion 211 by screws. Alternatively, for example, each first fixing member 5 may be solder, the second housing portion 212 may be soldered and fixed to the first housing portion 211, and the third housing portion 213 may be soldered and fixed to the first housing portion 211. It is to be noted that each first fixing member 5 may have another configuration, and the manner in which the second housing portion 212 is fixed to the first housing portion 211 and the manner in which the third housing portion 213 is fixed to the first housing portion 211 may be the same or different, and may be provided according to the actual situation, which will not be described herein.

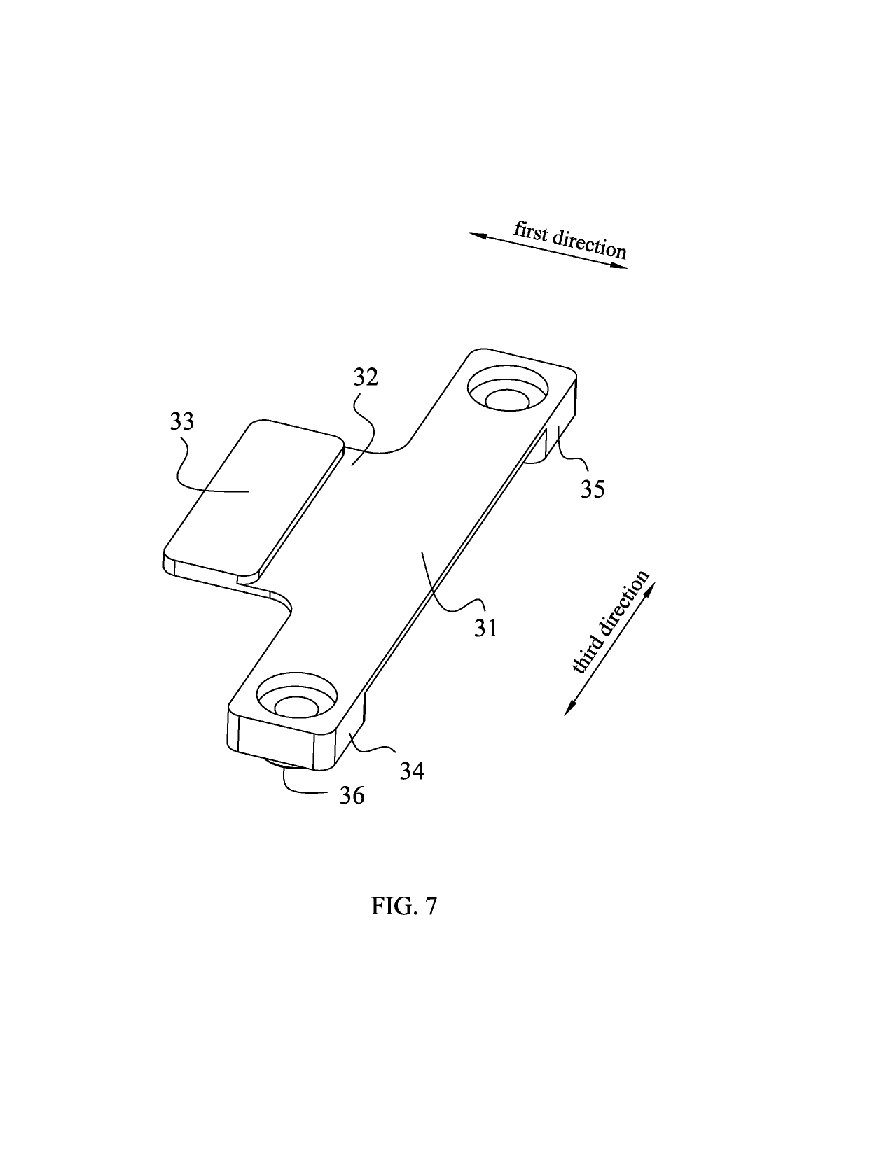

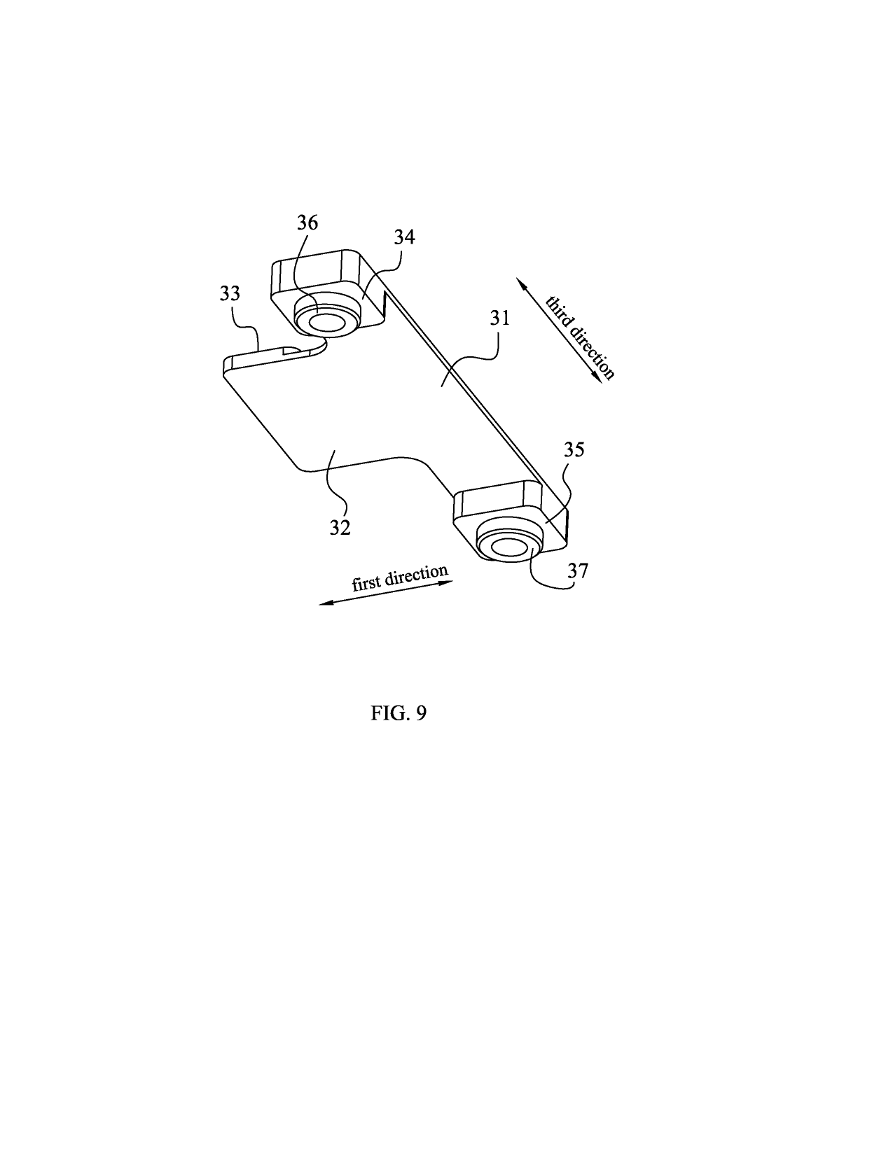

In some embodiments, referring to FIG. 5, the vibration motor includes two elastic members 3, and the two elastic members 3 are symmetrically arranged in the first direction. Referring to FIGS. 7 and 9, each elastic member 3 may be an elastic piece, and the elastic member 3 includes a first connection portion 31, a second connection portion 32, and a first convex portion 33 which are integrally connected in sequence. The second connection portion 32 is formed by extending from the middle of the first connection portion 31 in the first direction. The first convex portion 33 is provided at a free end of the second connection portion 32, that is, at an end of the second connection portion 32 away from the first connection portion 31. The first convex portion 33 is protruded on a side of the second connection portion 32 facing the cover plate 11. An end of the first connection portion 31 is fixed to the second housing portion 212, the other end of the first connection portion 31 is fixed to the third housing portion 213, and the first convex portion 33 is fixed to the cover plate 11, so that the cover plate 11 is suspended on the housing 21.

In the present embodiment, the two elastic members 3 cooperate with each other, not only can the cover plate 11 be stably and effectively suspended on the housing 21, so that the structure of the vibration motor is more stable, and the service life and reliability of the vibration motor can be effectively improved. In addition, each elastic member 3 is fixed to the cover plate 11 by the first convex portion 33 protruded on the second connection portion 32, so that it is more convenient to fix the elastic members 3 to the cover plate 11. A convex surface of each first convex portion 33 is matched with the cover plate 11, which can avoid the inability to effectively connect the elastic member 3 and the cover plate 11 caused by interference between other structures of the elastic member 3 and the cover plate 11, and further improve the stability and reliability of the vibration motor.

As an example, each elastic member 3 may be fixed to the cover plate 11 by second fixing members (not shown). For example, the second fixing member may be solder, and the elastic member 3 may be fixed to the cover plate 11 by soldering. It is to be noted that the second fixing member may have another structure, and may be provided according to the actual situation, which will not be described here.

In some embodiments, referring to FIGS. 7 and 9, each respective elastic member further includes a second convex portion 34 formed at one end of the first connection portion 31 in the third direction, and a third convex portion 35 formed at the other end of the first connection portion 31 in the third direction. The second convex portion 34 and the third convex portion 35 are symmetrically disposed with respect to the first connection portion 31. The second convex portion 34 and the third convex portion 35 are protruded on a side of the first connection portion 31 facing the housing 21. The respective elastic member further includes a fourth insertion portion 36 formed on the second convex portion 34. The fourth insertion portion 36 is formed on a side of the second convex portion 34 facing the housing 21. The fourth insertion portion 36 is protruded from the second convex portion 34. The respective elastic member further includes a fifth insertion portion 37 formed on the third convex portion 35. The fifth insertion portion 37 is formed on a side of the third convex portion 35 facing the housing 21, and the fifth insertion portion 37 is protruded from the third convex portion 35.

Accordingly, referring to FIGS. 6 and 10, the second housing portion 212 defines two fourth insertion holes 2122. The two fourth insertion holes 2122 are symmetrically defined at both ends of the second housing portion 212 in the first direction. One of the two fourth insertion holes 2122 is in a plug-in fit with the fourth insertion portion 36 of one of the elastic members 3, and the other of the two fourth insertion holes 2122 is in a plug-in fit with the fourth insertion portion 36 of the other of the elastic members 3. The third housing portion 213 defines two fifth insertion holes 2132. The two fifth insertion holes 2132 are symmetrically defined at both ends of the third housing portion 213 in the first direction. One of the two fifth insertion holes 2132 is in a plug-in fit with the fifth insertion portion 37 of one of the elastic members 3, and the other of the fifth insertion holes 2132 is in a plug-in fit with the fifth insertion portion 37 of the other of the elastic members 3.

In the present embodiment, each of the elastic members 3 is inserted into a corresponding fourth insertion hole 2122 through the fourth insertion portion 36 protruding from the second convex portion 34, and the elastic member 3 is also inserted into a corresponding fifth insertion hole 2132 through the fifth insertion portion 37 protruding from the third convex portion 35, so that the elastic members 3 are quickly and effectively restricted on the second housing portion 212 and the third housing portion 213. In this way, it is possible to improve the assembly accuracy, and facilitate the subsequent accurate and effective fixing of the elastic members 3 to the second housing portion 212 and the third housing portion 213, thus enhancing the assembly efficiency and further improving the stability of the housing 21.

As an example, each of the elastic members 3 may be fixed to the second housing portion 212 by a corresponding third fixing member 6, and fixed to the third housing portion 213 by a corresponding third fixing members 6. For example, with reference to FIGS. 5 and 8, each third fixing member 6 may be a screw. It is to be noted that, in other embodiments, the third fixing member 6 may have other structures and may be provided according to the actual situation, which will not be repeated here.

As an alternative embodiment, the second housing portion 212 may be a one-piece formed structure, and the second housing portion 212 includes a first plate body 2123 and two first column bodies 2124 that are integrally connected. The two first column bodies 2124 are symmetrically formed on both sides of the first plate body 2123 in the first direction. Each of the first column bodies 2124 has a first stepped surface 2125 on a side of the first column body 2124 facing the elastic members 3, and defines the fourth insertion hole 2122 on the first stepped surface 2125. The first stepped surface 2125 of one of the two first column bodies 2124 of the second housing portion 212 abuts on the second convex portion 34 of one of the elastic members 3, and the first stepped surface 2125 of the other of the two first column bodies 2124 of the second housing portion 212 abuts on the second convex portion 34 of the other of the elastic members 3.

Similarly, the third housing portion 213 may be a one-piece formed structure, and the third housing portion 213 includes a second plate body 2133 and two second column bodies 2134 that are integrally connected. The second column bodies 2134 are symmetrically formed on both sides of the second plate body 2133 in the first direction. Each of the second column bodies 2134 has a second stepped surface 2135 on a side of the second column body 2134 facing the elastic members 3, and defines the fifth insertion hole 2132 on the second stepped surface 2135. The second stepped surface 2135 of one of the two second column bodies 2134 of the third housing portion 213 abuts on the third convex portion 35 of one of the elastic members 3, and the second stepped surface 2135 of the other of the two second column bodies 2134 of the third housing portion 213 abuts on the third convex portion 35 of the other of the elastic members 3.

In the present embodiment, the second housing portion 212 has the first stepped surfaces 2125, and the third housing portion 213 has the second stepped surfaces 2135, so that the elastic members 3 can be more accurately and effectively restricted on the housing 21, which not only further improves the assembly accuracy, but also facilitates the subsequent accurate and effective fixing of the elastic members 3 to the second housing portion 212 and the third housing portion 213, thereby improving the assembly efficiency and further improving the stability of the housing 21 and the product yield.

In another embodiment, each fourth insertion hole may be defined on a corresponding second convex portion 34, and each fifth insertion hole may be defined on a corresponding third convex portion 35. Accordingly, the fourth insertion portions may be formed on the second housing portion 212, and the fifth insertion portions may be formed on the third housing portion 213. Specifically, each fourth insertion hole is defined on a side of the corresponding second convex portion 34 facing the housing 21, each fifth insertion hole is defined on a side of the corresponding third convex portion 35 facing the housing 21, the fourth insertion portions provided corresponding to the fourth insertion holes are symmetrically formed at both ends of the second housing portion 212 in the first direction, and the fifth insertion portions provided corresponding to the fifth insertion holes are symmetrically formed at both ends of the third housing portion 213 in the first direction. As an alternative embodiment, each of the fourth insertion portions is provided on a corresponding first stepped surface 2125, and each of the fifth insertion portions is provided on a corresponding second stepped surface 2135.

Furthermore, the first column bodies 2124 of the second housing portion 212 and the second column bodies 2134 of the third housing portion 213 are arranged in one-to-one correspondence. A distance between a respective first column body 2124 and a corresponding second column body 2134 is smaller than a distance between the first plate body 2123 and the second plate body 2133. An end of the second iron core 223 is fixed to the first plate body 2123, and the other end of the second iron core 223 is fixed to the second plate body 2133. An end of the third iron core 224 is fixed to the first plate body 2123, and the other end of the third iron core 224 is fixed to the second plate body 2133.

In the present embodiment, the distance between the respective first column body 2124 and the corresponding second column body 2134 is smaller than the distance between the first plate body 2123 and the second plate body 2133, which can prevent the second iron core 223 and the third iron core 224 from accidentally falling off from the housing 21, and further improve the stability of the housing 21 and the product yield.

As an example, referring to FIGS. 8, 10, and 11, each first fixing member 5 may be a screw, and the first fixing member 5 can pass through the first housing portion 211 and then may be screwed into a corresponding first column body 2124 of the second housing portion 212 or into a corresponding second column body 2134 of the third housing portion 213, thereby effectively fixing the first housing portion 211, the second housing portion 212, and the third housing portion 213 to form the housing 21. Referring to FIGS. 1, 5, 6, and 8, each third fixing member 6 may be a screw, and the third fixing member 6 can pass through a corresponding elastic member 3 and then may be screwed into a corresponding first column body 2124 of the second housing portion 212 or into a corresponding second column body 2134 of the third housing portion 213, thereby effectively fixing the elastic members 3 to the housing 21.

In some embodiments, the housing 21 is made of a highly magnetic permeable material.

In some embodiments, each of the first iron core 222, the second iron core 223, and the third iron core 224 is made of a highly magnetic permeable material.

In some embodiments, as shown in FIGS. 10 and 11, the electromagnet 22 may include a winding 221. In another embodiment, the electromagnet 22 may include a plurality of windings 221. As an example, the plurality of windings 221 may be coaxially disposed and sequentially sleeved on the first iron core 222.

In some embodiments, the first iron core 222 may be formed by laminating multiple layers of iron sheets, thereby reducing eddy current losses. It is to be noted that, in other embodiments, the first iron core 222 may be a one-piece formed structure, and may be provided according to actual circumstances, which will not be described herein.

In some embodiments, the second iron core 223 may be formed by laminating multiple layers of iron sheets, thereby reducing eddy current losses. It is to be noted that, in other embodiments, the second iron core 223 may be a one-piece formed structure, and may be provided according to actual circumstances, which will not be described here.

In some embodiments, the third iron core 224 may be formed by laminating multiple layers of iron sheets, thereby reducing eddy current losses. It is to be noted that, in other embodiments, the third iron core 224 may be a one-piece formed structure, and may be provided according to the actual situation, which will not be described here.

The above description is merely an embodiment of the present disclosure, and it is to be pointed out that for those skilled in the art, improvements can be made without departing from the inventive concept of the present disclosure, but these are all within the scope of protection of the present disclosure.

What is claimed is:

1. A vibration motor, comprising a mover, a stator, and elastic members, wherein the mover includes a cover plate, and the stator includes a housing and an electromagnet, wherein the cover plate and the housing are connected by the elastic members and define an accommodation space, the electromagnet is accommodated in the accommodation space, and the electromagnet includes at least one winding, a first iron core, a second iron core, and a third iron core, wherein the first iron core, the second iron core, and the third iron core are fixed to the housing, the second iron core and the third iron core are provided symmetrically on both sides of the first iron core in a first direction and are both spaced apart from the first iron core, and the at least one winding surrounds the first iron core and is located between the second iron core and the third iron core;
wherein in response to a periodic current being applied to the at least one winding, the stator generates a periodic magnetic attraction force to the mover to cause the mover to move in a second direction perpendicular to the first direction.

2. The vibration motor of claim 1, wherein the housing includes a first housing portion, a second housing portion, and a third housing portion, wherein the second housing portion and the third housing portion are symmetrically fixed to the first housing portion in a third direction, and the third direction is perpendicular to the first direction and the second direction, wherein the first iron core is fixed to the first housing portion, the second iron core has an end fixed to the second housing portion and has another end fixed to the third housing portion, and the third iron core has an end fixed to the second housing portion and has another end fixed to the third housing portion.

3. The vibration motor of claim 2, wherein the first housing portion defines a first insertion hole, the second housing portion defines two second insertion holes symmetrically defined in the first direction, and the third housing portion defines third insertion holes that are in one-to-one correspondence with the two second insertion holes;
wherein the first iron core includes a first main body surrounded by the at least one winding and a first insertion portion protruding from the first main body, and the first insertion portion is inserted into the first insertion hole;
wherein the second iron core includes a second main body and two second insertion portions symmetrically arranged on both sides of the second main body in the third direction, wherein one of the two second insertion portions is inserted into one second insertion hole of the two second insertion holes, and another second insertion portion of the two second insertion portions is inserted into a third insertion hole corresponding to the one second insertion hole; and
wherein the third iron core includes a third main body and two third insertion portions symmetrically arranged on both sides of the third main body in the third direction, wherein one of the two third insertion portions is inserted into another second insertion hole of the two second insertion holes, and another third insertion portion of the two third insertion portions is inserted into a third insertion hole corresponding to the other second insertion hole.

4. The vibration motor of claim 2, wherein the housing is a one-piece formed structure, or wherein the housing is a split structure, and each of the second housing portion and the third housing portion is fixed to the first housing portion through first fixing members.

5. The vibration motor of claim 2, wherein the vibration motor includes two elastic members provided symmetrically in the first direction, wherein each respective elastic member of the two elastic members includes a first connection portion, a second connection portion formed by extending from a middle of the first connection portion in the first direction, and a first convex portion provided at a free end of the second connection portion, wherein the first connection portion has an end fixed to the second housing portion and has another end fixed to the third housing portion, and the first convex portion is protruded on a side of the second connection portion facing the cover plate and fixed to the cover plate.

6. The vibration motor of claim 5, wherein the respective elastic member further comprises a second convex portion formed at an end of two ends of the first connection portion in the third direction, and a third convex portion formed at another end of the two ends of the first connection portion in the third direction, wherein the second convex portion and the third convex portion are symmetrically disposed with respect to the first connection portion, and are protruded on a side of the first connection portion facing the housing; and
wherein the respective elastic member further comprises a fourth insertion portion protruding from a side of the second convex portion facing the housing, and a fifth insertion portion protruding from a side of the third convex portion facing the housing, and wherein the second housing portion defines two fourth insertion holes, wherein the two fourth insertion holes are symmetrically defined at both ends of the second housing portion in the first direction, and are provided corresponding to the fourth insertion portions, and wherein the third housing portion defines two fifth insertion holes, wherein the two fifth insertion holes are symmetrically defined at both ends of the third housing portion in the first direction, and are provided corresponding to the fifth insertion portions; or
wherein the respective elastic member further defines a fourth insertion hole defined on the side of the second convex portion facing the housing, and a fifth insertion hole defined on the side of the third convex portion facing the housing, and wherein the second housing portion further comprises the fourth insertion portions, wherein the fourth insertion portions are symmetrically formed at both ends of the second housing portion in the first direction, and are provided corresponding to the two fourth insertion holes, and wherein the third housing portion further comprises the fifth insertion portions, wherein the fifth insertion portions are symmetrically formed at both ends of the third housing portion in the first direction, and are provided corresponding to the two fifth insertion holes.

7. The vibration motor of claim 6, wherein the second housing portion includes a first plate body and first column bodies formed symmetrically on both sides of the first plate body in the first direction, each respective first column body of the first column bodies has a first stepped surface on a side of the respective first column body facing the elastic members and abutting on the second convex portion, and the fourth insertion hole or the fourth insertion portion is provided on the first stepped surface;
wherein the third housing portion includes a second plate body and second column bodies formed symmetrically on both sides of the second plate body in the first direction, each respective second column body of the second column bodies has a second stepped surface on a side of the respective second column body facing the elastic members and abutting on the third convex portion, and the fifth insertion hole or the fifth insertion portion is provided on the second stepped surface;
wherein the first column bodies and the second column bodies are arranged in one-to-one correspondence, and a distance between a respective one of the first column bodies and a corresponding one of the second column bodies is smaller than a distance between the first plate body and the second plate body; and
wherein the second iron core has an end fixed to the first plate body and has another end fixed to the second plate body, and the third iron core has an end fixed to the first plate body and has another end fixed to the second plate body.

8. The vibration motor of claim 1, wherein the housing is made of a highly magnetic permeable material.

9. The vibration motor of claim 1, wherein each of the first iron core, the second iron core, and the third iron core is made of a highly magnetic permeable material.

10. The vibration motor of claim 1, wherein the at least one winding is embodied as a plurality of windings, and the plurality of windings are coaxially disposed and sequentially sleeved on the first iron core.

11. The vibration motor of claim 1, wherein each of at least one of the first iron core, the second iron core, and the third iron core is formed by laminating a plurality of layers of iron sheets.
